(19) United States
(12) Patent Application Publication
(10) Pub. No.: US 2025/0369358 A1
(43) Pub. Date: Dec. 4, 2025

(54) ROTOR BLADE AND GAS TURBINE PROVIDED WITH SAME

(71) Applicant: MITSUBISHI HEAVY INDUSTRIES, LTD., Tokyo (JP)

(72) Inventors: Takashi NIUCHI, Tokyo (JP); Yasuo MIYAHISA, Tokyo (JP); Shunsuke TORII, Tokyo (JP)

(21) Appl. No.: 18/873,601

(22) PCT Filed: Jun. 7, 2023
(86) PCT No.: PCT/JP2023/021164

§ 371 Date: Dec. 10, 2024

(30) Foreign Application Priority Data
Jun. 15, 2022 (JP) 2022-096561

(51) Int. Cl. F01D 5/18

(52) U.S. Cl. CPC F01D 5/186; F01D 5/18; F05D 2220/32; F05D 2240/30; F05D 2260/202

(57) ABSTRACT

A cooling air passage of a rotor blade has: a main passage into which cooling air can flow; a plurality of leading ejection holes that can eject the cooling air from a leading edge in the blade surface; and a plurality of film holes that have a blade surface ejection port opened at a negative pressure surface of the blade body, and can eject the cooling air from the blade surface ejection port along the blade surface. The main passage has an odd number of three or more intra-blade passages extending in the blade height direction inside the blade body. The plurality of leading ejection holes communicate with a first intra-blade passage most on the leading side among the odd number of intra-blade passages. The plurality of film holes communicate with a second intra-blade passage adjacent to the first intra-blade passage among the odd number of intra-blade passages.

### TECHNICAL FIELD

The present invention relates to a rotor blade and a gas turbine provided with the same.

This application claims the right of priority based on Japanese Patent Application No. 2022-096561 filed with the Japan Patent Office on Jun. 15, 2022, the content of which is incorporated herein by reference.

### BACKGROUND ART

A gas turbine includes a compressor that compresses air to generate compressed air, a combustor that combusts a fuel in the compressed air to generate a combustion gas, and a turbine driven by the combustion gas. The turbine includes a turbine rotor that rotates around an axis, a turbine casing that covers the rotor, and a plurality of stator blade rows. The turbine rotor includes a rotor shaft around the axis, and a plurality of rotor blade rows attached to the rotor shaft. The plurality of rotor blade rows are arranged in an axial direction where the axis extends. Each of the rotor blade rows includes a plurality of rotor blades arranged in a circumferential direction with respect to the axis. The plurality of stator blade rows are arranged in the axial direction, and are attached to an inner peripheral side of the turbine casing. Each of the plurality of stator blade rows is disposed on an axial upstream side of any one rotor blade row of the plurality of rotor blade rows. Each of the stator blade rows includes a plurality of stator blades arranged in the circumferential direction with respect to the axis.

The rotor blade generally includes a blade body, a platform, and a blade root. The blade body has a cross section perpendicular to a radial direction with respect to the axis to form an airfoil, and extends in the radial direction. The platform is provided at an end of the blade body on a radial inner side. The blade root is provided on a radial inner side of the platform. This blade root is a portion which attaches the rotor blade to the rotor shaft.

The rotor blade of the gas turbine is exposed to a high-temperature combustion gas. Therefore, the rotor blade is generally cooled by air or the like.

For example, in a rotor blade described in the following PTL 1, two cooling air passages through which cooling air can be circulated are formed in a blade body of a stator blade. Each of the two cooling air passages includes a main passage having an inlet which is open in a surface of a blade root and into which cooling air can flow, and a plurality of end holes through which the cooling air that has been passed through the main passage can be ejected to the outside from an end portion of the blade body. The main passage of each cooling air passage includes an introduction passage portion extending from an inlet of the blade root to a boundary between the platform and the blade body, and a blade body cooling passage portion having three intra-blade passages extending in a radial direction in the blade body. The three intra-blade passages are arranged along a camber line of the blade body. In the three intra-blade passages, the intra-blade passages adjacent to each other communicates with each other at one end out of a radial inner side and a radial outer side such that a passage of the blade body cooling passage portion meanders in the radial direction to configure one serpentine passage. A first cooling air passage of the two cooling air passages is disposed on a leading side in the blade body, and a second cooling air passage is disposed on a trailing side in the blade body. A plurality of leading ejection holes as the plurality of end holes communicate with an intra-blade passage on a most leading side among the three intra-blade passages of the first cooling air passage. The plurality of leading ejection holes are open in a leading edge peripheral portion including the leading edge in the blade surface. In addition, a plurality of trailing ejection holes as the plurality of end holes communicate with an intra-blade passage on a most trailing side among the three intra-blade passages of the second cooling air passage. The plurality of trailing ejection holes are open in a trailing edge of the blade body.

### Citation List

### Patent Literature

[PTL 1] Japanese Unexamined Patent Application Publication No. 2014-001633

### SUMMARY OF INVENTION

### Technical Problem

It is required to increase durability of a rotor blade of a gas turbine exposed to high-temperature combustion gas while suppressing an amount of cooling air used.

Therefore, an object of the present disclosure is to provide a rotor blade capable of increasing durability while suppressing the amount of cooling air used, and a gas turbine provided with the rotor blade.

### Solution to Problem

According to an aspect of the invention for achieving the objects, there is provided a rotor blade including: a blade body that has a cross section forming an airfoil and that extends in a blade height direction including a direction component perpendicular to the cross section; a platform that is provided at an end of a hub side of the blade body, out of a tip side and the hub side in the blade height direction; a blade root that is provided on the hub side of the platform; and a cooling air passage that is formed over the blade root, the platform, and the blade body and through which cooling air is allowed to be circulated. The blade body has a blade surface facing a direction having a direction component perpendicular to the blade height direction, and a tip surface facing the tip side in the blade height direction. The blade surface has a leading edge and a trailing edge extending in the blade height direction, and a positive pressure surface and a negative pressure surface spreading from the leading edge to the trailing edge. The cooling air passage includes a main passage that has an inlet which is open on a surface of the blade root and into which cooling air is able to flow, a plurality of leading ejection holes that include a leading ejection port open in a leading edge peripheral portion, which is a portion that includes the leading edge and faces a leading side which is a side of the leading edge with respect to the trailing edge, in the blade surface, and through which the cooling air that has been passed through the main passage is allowed to be ejected from the leading ejection ports, and a plurality of film holes that include a blade surface ejection port which excludes the leading edge peripheral portion, in the blade surface, and is open in at least one blade surface of the positive pressure surface and the negative pressure surface, and through which the cooling air that has been passed through the main passage is allowed to be ejected to an outside along the at least one blade surface from the blade surface ejection port. The main passage has an introduction passage portion that extends from the inlet to a boundary between the platform and the blade body, and a blade body cooling passage portion that has three or more odd-numbered intra-blade passages extending in the blade height direction in the blade body. The odd-numbered intra-blade passages are arranged from the introduction passage portion to the leading side along a camber line of the blade body. Intra-blade passages adjacent to each other among the odd-numbered intra-blade passages communicate with each other at one end out of an end on the hub side and an end on the tip side such that the blade body cooling passage portion configures one serpentine passage in which a passage meanders in the blade height direction. The plurality of leading ejection holes communicate with a first intra-blade passage positioned on a most leading side among the odd-numbered intra-blade passages. The plurality of film holes communicate with at least one intra-blade passage of the first intra-blade passage and a second intra-blade passage adjacent to the first intra-blade passage among the odd-numbered intra-blade passages. An aperture ratio which is an area of the blade surface ejection port per unit area on the hub side is higher than an aperture ratio which is an area of the blade surface ejection port per unit area on the tip side, based on a middle position of the blade body in the blade height direction.

In the present aspect, the cooling air that flows into the main passage from the inlet of the main passage in the cooling air passage flows into the blade body cooling passage portion of the main passage through the introduction passage portion of the main passage. The cooling air is convectively cooled around each of the intra-blade passages in a process of flowing through the three or more odd-numbered intra-blade passages in the blade body cooling passage portion. A part of the cooling air flowing through the three or more odd-numbered intra-blade passages is ejected to the outside along the positive pressure surface or the negative pressure surface from the plurality of film holes. A part of the cooling air is convectively cooled around the film holes in a process of flowing through the plurality of film holes. Further, the cooling air ejected from the plurality of film holes film-cools the positive pressure surface or the negative pressure surface. A part of the cooling air that has flowed into the first intra-blade passage positioned on a downstream side of the flow of the cooling air on the most leading side among the three or more odd-numbered intra-blade passages is ejected to the outside from the plurality of leading ejection holes. A part of the cooling air is convectively cooled around the leading ejection hole in a process of flowing through the plurality of leading ejection holes. Further, the cooling air ejected from the plurality of leading ejection holes suppresses direct collision of the high-temperature combustion gas with the leading edge peripheral portion which is a part of the blade surface.

Meanwhile, a blade width which is a distance between the positive pressure surface and the negative pressure surface gradually increases from the tip side of the blade body toward the hub side. In addition, a distance between an inner surface of the intra-blade passage and the blade surface is a distance within a predetermined range from the viewpoint of cooling the blade surface. In this relationship, the widths of the plurality of intra-blade passages extending in the blade height direction also gradually increase from the tip side of the blade body toward the hub side. In a case where the width of the intra-blade passage gradually increases from the tip side of the blade body toward the hub side, a flow velocity of the cooling air flowing through the intra-blade passage is lower on the hub side than on the tip side. Therefore, a heat transfer coefficient between the cooling air flowing through the portion of the intra-blade passage on the hub side and the blade body is lower than a heat transfer coefficient between the cooling air flowing through the portion of the intra-blade passage on the tip side and the blade body. Therefore, the convection cooling effect of the cooling air flowing through the intra-blade passage is low in a portion of the blade body on the hub side.

Therefore, in the present aspect, the durability of the rotor blade is increased by improving the film cooling effect on the portion on the hub side by setting the aperture ratio that is the area of the blade surface ejection port per unit area on the hub side to be higher than the aperture ratio that is the area of the blade surface ejection port per unit area on the tip side, based on the middle position in the blade height direction in the blade body.

In addition, in the present aspect, the cooling air flowing into the plurality of film holes is cooling air that flows from a most trailing side intra-blade passage to at least a downstream side portion of the second intra-blade passage among the three or more odd-numbered intra-blade passages, and is the cooling air that has already been heated to some extent. The downstream side here is the downstream side of the flow of the cooling air. In the present aspect, as described above, since the cooling air that has been heated to some extent and that has a low convection cooling effect is used as the air for film cooling, the blade surface can be efficiently cooled without wasting the cold cooling air. Further, in the present aspect, the cooling air flowing into the plurality of leading ejection holes is cooling air that has flowed from the intra-blade passage on the most trailing side to the first intra-blade passage among the three or more odd-numbered intra-blade passages, and is cooling air that has already been considerably heated. An upstream side here is the upstream side of the flow of the cooling air. In the present aspect, as described above, since the cooling air that has been considerably heated and that has a low convection cooling effect is used as the cooling air for the leading edge peripheral portion that is a part of the blade surface, the blade surface can be efficiently cooled without wasting the cold cooling air.

Therefore, in the present aspect, it is possible to increase the durability of the rotor blade while suppressing the amount of cooling air used.

According to another aspect of the invention for achieving the objects, there is provided a gas turbine including: a plurality of the rotor blades according to the aspect; a rotor shaft that is rotatable about an axis and to which the plurality of rotor blades are attached to be arranged in a circumferential direction with respect to the axis; and a turbine casing that covers an outer peripheral side of the plurality of rotor blades and the rotor shaft. The rotor blade is attached to the rotor shaft such that the blade height direction is a radial direction with respect to the axis, the hub side is a radial outer side out of a radial inner side and the radial outer side in the radial direction with respect to the axis, and the leading side is an axial upstream side out of the axial upstream side and an axial downstream side in an axial direction in which the axis extends.

### Advantageous Effects of Invention

According to one aspect of the present disclosure, it is possible to increase durability of the rotor blade while suppressing an amount of cooling air used.

### BRIEF DESCRIPTION OF DRAWINGS

FIG. 1 is a schematic cross-sectional view of a gas turbine according to an embodiment of the present disclosure.

FIG. 2 is a perspective view of a rotor blade according to a first embodiment of the present disclosure.

FIG. 3 is a side view of the rotor blade according to the first embodiment of the present disclosure (side view of the rotor blade as viewed from a negative pressure surface side).

FIG. 4 is a cross-sectional view of the rotor blade according to the first embodiment of the present disclosure.

FIG. 5 is a cross-sectional view taken along line V-V in FIG. 3.

FIG. 6 is a cross-sectional view taken along line VI-VI in FIG. 3.

FIG. 7 is a side view of a rotor blade according to a second embodiment of the present disclosure (side view of the rotor blade as viewed from a negative pressure surface side).

FIG. 8 is a cross-sectional view taken along line VIII-VIII in FIG. 7.

FIG. 9 is a side view of a rotor blade according to a third embodiment of the present disclosure (side view of the rotor blade as viewed from a positive pressure surface side).

FIG. 10 is a cross-sectional view taken along line X-X in FIG. 9.

### DESCRIPTION OF EMBODIMENTS

Hereinafter, embodiments of a rotor blade of the present disclosure and a gas turbine including the rotor blade will be described in detail with reference to the drawings.

### Embodiment of Gas Turbine

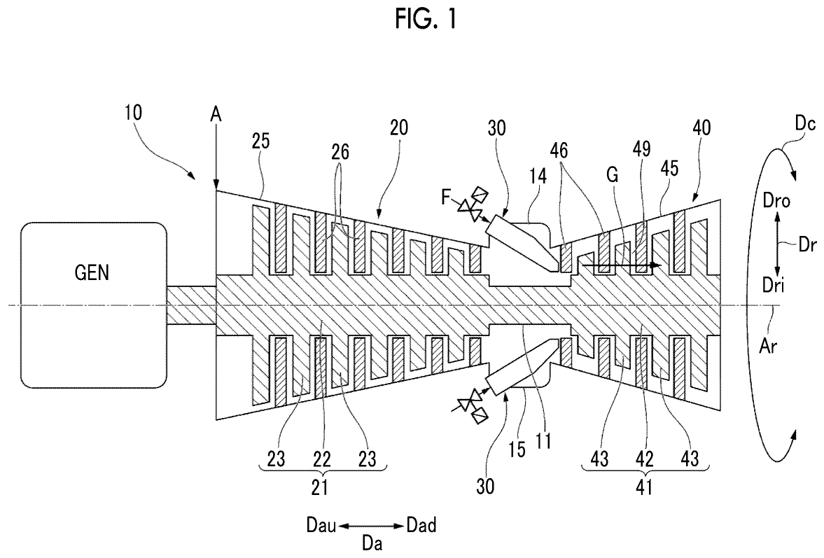

An embodiment of a gas turbine will be described with reference to FIG. 1.

As illustrated in FIG. 1, a gas turbine 10 of the present embodiment includes a compressor 20 that compresses air A, a combustor 30 that combusts a fuel F in the air A compressed by the compressor 20 to generate a combustion gas G, and a turbine 40 driven by the combustion gas G.

The compressor 20 includes a compressor rotor 21 that rotates around an axis Ar, a compressor casing 25 that covers the compressor rotor 21, and a plurality of stator blade rows 26. The turbine 40 includes a turbine rotor 41 that rotates around the axis Ar, a turbine casing 45 that covers the turbine rotor 41, and a plurality of stator blade rows 46. Hereinafter, an extending direction of the axis Ar will be referred to as an axial direction Da, a circumferential direction around the axis Ar will be simply referred to as a circumferential direction Dc, and a direction perpendicular to the axis Ar will be referred to as a radial direction Dr. In addition, one side in the axial direction Da will be referred to as an axial upstream side Dau, and a side opposite thereto will be referred to as an axial downstream side Dad. In addition, a side closer to the axis Ar in the radial direction Dr will be referred to as a radial inner side Dri, and a side opposite thereto will be referred to as a radial outer side Dro.

The compressor 20 is disposed on the axial upstream side Dau with respect to the turbine 40.

The compressor rotor 21 and the turbine rotor 41 are positioned on the same axis Ar and are connected to each other to form a gas turbine rotor 11. For example, a rotor of a generator GEN is connected to the gas turbine rotor 11. The gas turbine 10 further includes an intermediate casing 14. The intermediate casing 14 is disposed between the compressor casing 25 and the turbine casing 45 in the axial direction Da. The compressor casing 25, the intermediate casing 14, and the turbine casing 45 are connected to each other to form a gas turbine casing 15.

The compressor rotor 21 includes a rotor shaft 22 extending in the axial direction Da around the axis Ar, and a plurality of rotor blade rows 23 attached to the rotor shaft 22. The plurality of rotor blade rows 23 are arranged in the axial direction Da. Each of the rotor blade rows 23 is configured by a plurality of rotor blades arranged in the circumferential direction Dc. One stator blade row 26 of the plurality of stator blade rows 26 is disposed on the axial downstream side Dad of each of the plurality of rotor blade rows 23. Each of the stator blade rows 26 is provided inside the compressor casing 25. Each of the stator blade rows 26 is configured by a plurality of stator blades arranged in the circumferential direction Dc.

The turbine rotor 41 includes a rotor shaft 42 extending in the axial direction Da around the axis Ar, and a plurality of rotor blade rows 43 attached to the rotor shaft 42. The plurality of rotor blade rows 43 are arranged in the axial direction Da. Each of the rotor blade rows 43 is configured by a plurality of rotor blades arranged in the circumferential direction Dc. For each of the plurality of the rotor blade rows 43, one stator blade row 46 of the plurality of stator blade rows 46 is disposed on the axial upstream side Dau. Each of the stator blade rows 46 is provided inside the turbine casing 45. Each of the stator blade rows 46 is configured by a plurality of stator blades arranged in the circumferential direction Dc.

The combustor 30 is attached to the intermediate casing 14.

The compressor 20 compresses the air A to generate compressed air. The compressed air flows into the combustor 30. The fuel F is supplied to the combustor 30. In the combustor 30, the fuel F is combusted in the compressed air so that the combustion gas G of which the temperature and the pressure are high is generated. The combustion gas G is sent from the combustor 30 to an annular combustion gas passage 49 in the turbine casing 45. The combustion gas G rotates the turbine rotor 41 in a process of flowing through the combustion gas passage 49 toward the axial downstream side Dad. The rotor of the generator GEN connected to the gas turbine rotor 11 is rotated as the turbine rotor 41 rotates. As a result, the generator GEN generates electricity.

Hereinafter, embodiments of the rotor blade constituting the first stage rotor blade row 43 of the turbine 40 and modification examples thereof will be described.

### First Embodiment of Rotor Blade

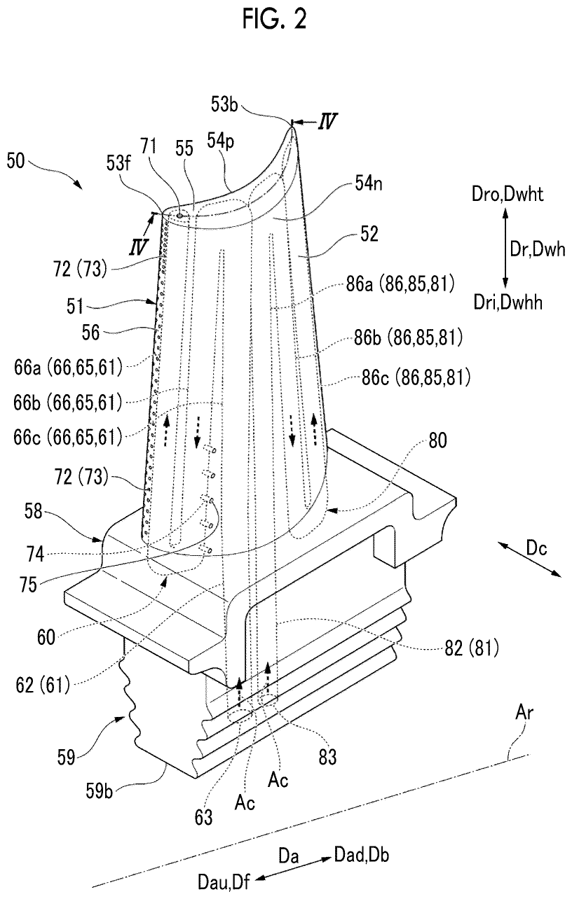

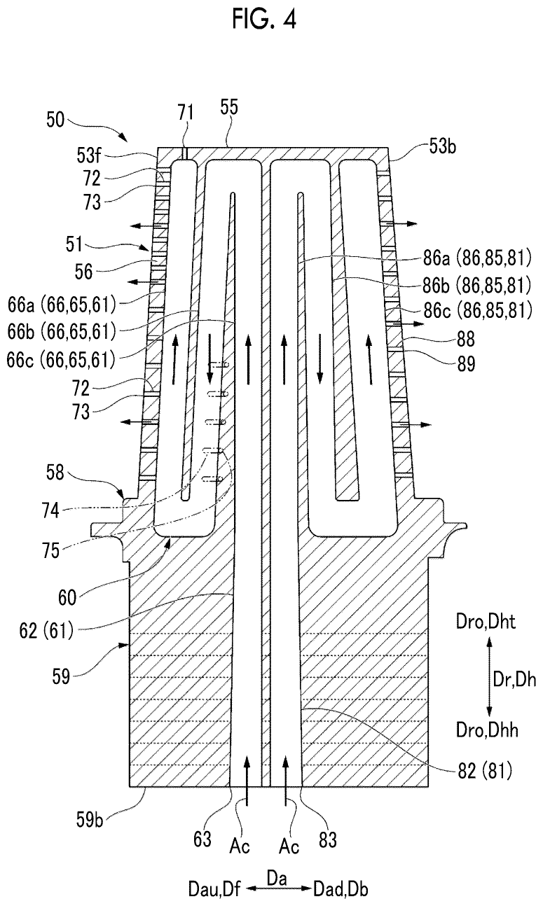

The first embodiment of the rotor blade will be described with reference to FIGS. 2 to 6.

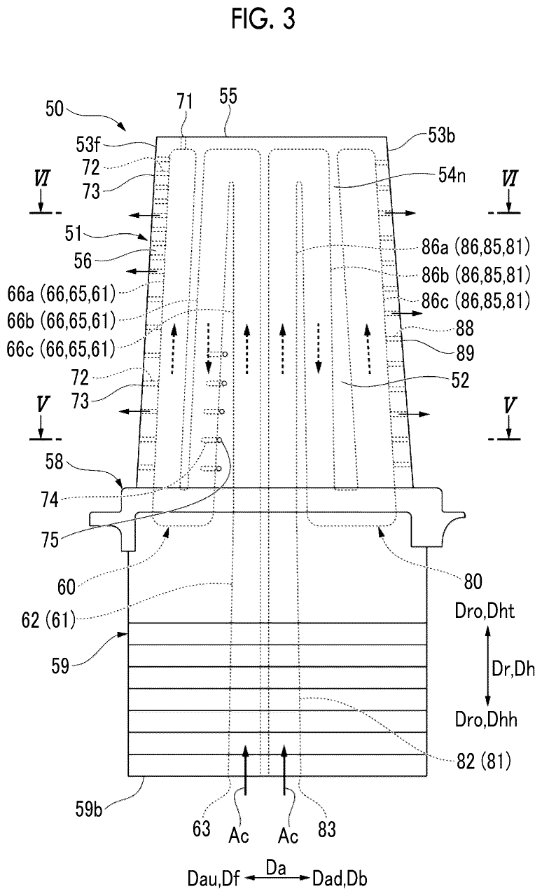

As illustrated in FIGS. 2 and 3, a rotor blade 50 according to the present embodiment includes a blade body 51, a platform 58, a blade root 59, a first cooling air passage 60, and a second cooling air passage 80.

The blade body 51 has a cross section forming an airfoil, and extends in a blade height direction Dh including a direction component perpendicular to the cross section. The blade body 51 has a blade surface 52 facing a direction having a direction component perpendicular to the blade height direction Dh and a tip surface 5 facing a tip side Dht out of the tip side Dht and a hub side Dhh in the blade height direction Dh. The blade surface 52 has a leading edge 53f and a trailing edge 53b extending in the blade height direction Dh, and a positive pressure surface 54p and a negative pressure surface 54n that spread from the leading edge 53f to the trailing edge 53b. The positive pressure surface 54p and the negative pressure surface 54n are in a relationship of being opposite to each other. The positive pressure surface 54p is a recessed curved surface, and the negative pressure surface 54n is a protruding curved surface.

In a case where the rotor blade 50 is attached to the rotor shaft 42, the blade height direction Dh is the radial direction Dr, the tip side Dht is the radial outer side Dro, and the hub side Dhh is the radial inner side Dri. In addition, a leading side Df in which the leading edge 53f is present with respect to the trailing edge 53b is the axial upstream side Dau, and a trailing side Db in which the trailing edge 53b is present with respect to the leading edge 53f is the axial downstream side Dad. Further, a direction in which the positive pressure surface 54p and the negative pressure surface 54n are arranged is the circumferential direction De. In addition, in a case where the rotor blade 50 is attached to the rotor shaft 42, the blade body 51 is positioned in the combustion gas passage 49.

The platform 58 is provided on the hub side Dhh of the blade body 51. The platform 58 is a square plate-shaped member that spreads in a direction including a direction component of a direction perpendicular to the radial direction Dr, which is the blade height direction Dh.

The blade root 59 is provided on the hub side Dhh of the platform 58. The blade root 59 is a portion for attaching the rotor blade 50 to the rotor shaft 42. The blade root 59 has a cross-sectional shape that forms a Christmas tree shape.

Both the first cooling air passage 60 and the second cooling air passage 80 are passages which are formed over the blade root 59, the platform 58, and the blade body 51 and through which cooling air Ac can be circulated. The second cooling air passage 80 is disposed in the rotor blade 50 on the trailing side Db of the first cooling air passage 60.

The first cooling air passage 60 includes a main passage 61, a tip ejection hole 71, a plurality of leading ejection holes 72, and a plurality of film holes 74. The main passage 61 is open in a bottom surface 59b of the blade root 59 and has an inlet 63 into which the cooling air Ac from the rotor shaft 42 can flow. The bottom surface 59b of the blade root 59 is a surface that is positioned closest to the hub side Dhh and faces the hub side Dhh in the surface of the blade root 59. The main passage 61 includes an introduction passage portion 62 that extends from the inlet 63 to a boundary between the platform 58 and the blade body 51 in the blade height direction Dh, and a blade body cooling passage portion 65 that is provided in the blade body 51 and that has three intra-blade passages 66 extending in the blade height direction Dh.

The three intra-blade passages 66 are arranged on the leading side Df from the introduction passage portion 62 along a camber line CL of the blade body 51. Here, among the three intra-blade passages 66, the intra-blade passage 66 on the most leading side Df is referred to as a first intra-blade passage 66a, the intra-blade passage 66 adjacent to the first intra-blade passage 66a is referred to as a second intra-blade passage 66b, and the intra-blade passage 66 adjacent to the second intra-blade passage 66b as the intra-blade passage 66 positioned on the most trailing side Db is referred to as a third intra-blade passage 66c. The third intra-blade passage 66c extends from the introduction passage portion 62 in the blade height direction Dh.

The intra-blade passages 66 adjacent to each other among the three intra-blade passages 66 communicate with each other at one end out of the end on the hub side Dhh and the end on the tip side Dht such that the blade body cooling passage portion 65 configures one serpentine passage in which the passage meanders in the blade height direction Dh. Specifically, the end of the third intra-blade passage 66c on the tip side Dht and the end of the second intra-blade passage 66b on the tip side Dht communicate with each other, and the end of the second intra-blade passage 66b on the hub side Dhh and the end of the first intra-blade passage 66a on the hub side Dhh communicate with each other.

The tip ejection hole 71 communicates with the end of the first intra-blade passage 66a on the tip side Dht and is open on the tip surface 55.

All of the plurality of leading ejection holes 72 have leading ejection ports 73 that are open in a leading edge peripheral portion 56, which is a portion including the leading edge 53f and facing the leading side Df, in the blade surface 52. The leading edge peripheral portion 56 is a portion of a range obtained by combining a range from the leading edge 53f to the trailing side Db by a predetermined distance along the positive pressure surface 54p and a range from the leading edge 53f to the trailing side Db by a predetermined distance along the negative pressure surface 54n in the blade surface 52. Here, for example, the predetermined distance is a distance of 1/20, for example, of a distance from the leading edge 53f to the trailing edge 53b along the positive pressure surface 54p (or the negative pressure surface 54n). All of the plurality of leading ejection holes 72 communicate with the first intra-blade passage 66a. extend from the first intra-blade passage 66a in a predetermined direction, and are open in the leading edge peripheral portion 56 in the blade surface 52. Here, the predetermined direction is a direction in which the number of components in a direction parallel to a normal line of the blade surface 52 at the position of the leading ejection port 73 is larger than the number of components in a direction parallel to a tangent line of the blade surface 52 at the position of the leading ejection port 73.

The leading ejection port 73 of each of the plurality of leading ejection holes 72 is formed from the hub side Dhh to the tip side Dht in the leading edge peripheral portion 56. However, an aperture ratio which is an area of the leading ejection port 73 per unit area in the portion on the tip side Dht is higher than an aperture ratio which is an area of the leading ejection port 73 per unit area in the portion on the hub side Dhh, based on a middle position of the leading edge peripheral portion 56 in the blade height direction Dh. Specifically, in the present embodiment, the number of leading ejection ports 73 on the tip side Dht is larger than the number of leading ejection ports 73 on the hub side Dhh, based on the middle position of the blade height direction Dh in the leading edge peripheral portion 56.

All of the plurality of film holes 74 have blade surface ejection ports 75 that are open in at least one of the positive pressure surface 54p or the negative pressure surface 54n in the blade surface $2 except for the leading edge peripheral portion 56 in the blade surface 52. All of the plurality of film holes 74 communicate with at least one intra-blade passage 66 of the three intra-blade passages 66, extend from the intra-blade passage 66 in a predetermined direction, and are open in the at least one blade surface 52 described above. Here, the predetermined direction is a direction in which the number of components in a direction parallel to a tangent line of the blade surface 52 at the position of the blade surface ejection port 75 is larger than the number of components in a direction parallel to a normal line of the blade surface 52 at the position of the blade surface ejection port 75 and toward the trailing side Db. In addition, the plurality of film holes 74 in the present embodiment communicate with the second intra-blade passage 66b, and each of the blade surface ejection ports 75 thereof is open only on the negative pressure surface 54n.

The aperture ratio which is the area of the blade surface ejection port 75 per unit area in the portion on the hub side Dhh is higher than the aperture ratio which is the area of the blade surface ejection port 75 per unit area in the portion on the tip side Dht, based on the middle position of the blade height direction Dh on at least one blade surface 52. Specifically, in the present embodiment, the number of blade surface ejection ports 75 in the portion on the hub side Dhh is larger than the number of blade surface ejection ports 75 in the portion on the tip side Dht, based on the middle position of the blade height direction Dh on at least one blade surface 52. More specifically, in the present embodiment, the plurality of blade surface ejection ports 75 are formed only in the portion on the hub side Dhh, and the blade surface ejection ports 75 are not formed in the portion on the tip side Dht. In addition, in a case where the number of blade surface ejection ports 75 is more on the hub side Dhh than on the tip side Dht, based on the middle position of the blade height direction Dh in at least one blade surface 52 described above, the blade surface ejection ports 75 may be formed on the tip side Dht.

The second cooling air passage 80 includes a main passage 81 and a plurality of trailing ejection holes 88. The main passage 81 is open on the bottom surface 59b of the blade root 59 and has an inlet 83 into which the cooling air Ac from the rotor shaft 42 can flow. The inlet 83 of the main passage 81 in the second cooling air passage 80 is formed on the trailing side Db with respect to the inlet 63 of the main passage 61 in the first cooling air passage 60. The main passage 81 includes an introduction passage portion 82 that extends from the inlet 83 to a boundary between the platform 58 and the blade body 51 in the blade height direction Dh, and a blade body cooling passage portion 85 that has three intra-blade passages 86 extending in the blade height direction Dh in the blade body 51.

The three intra-blade passages 86 are arranged on the trailing side Db from the introduction passage portion 82 along the camber line CL of the blade body 51. Here, among the three intra-blade passages 86, the intra-blade passage 86 on the most leading side Df is referred to as a fourth intra-blade passage 86a, the intra-blade passage 86 adjacent to the fourth intra-blade passage 86a is referred to as a fifth intra-blade passage 86b, and the intra-blade passage 86 adjacent to the fifth intra-blade passage 86b as the intra-blade passage 86 positioned on the most trailing side Db is referred to as a sixth intra-blade passage 86c. The fourth intra-blade passage 86a extends from the introduction passage portion 82 in the blade height direction Dh.

The intra-blade passages 86 adjacent to each other among the three intra-blade passages 86 communicate with each other at one end out of the end on the hub side Dhh and the end on the tip side Dht such that the blade body cooling passage portion 85 configures one serpentine passage in which the passage meanders in the blade height direction Dh. Specifically, the end of the fourth intra-blade passage 86a on the tip side Dht and the end of the fifth intra-blade passage 86b on the tip side Dht communicate with each other, and the end of the fifth intra-blade passage 86b on the hub side Dhh and the end of the sixth intra-blade passage 86c on the hub side Dhh communicate with each other.

All of the plurality of trailing ejection holes 88 have trailing ejection ports 89 that are open in the trailing edge 53b. The plurality of trailing ejection holes 88 are arranged in the blade height direction Dh. All of the plurality of trailing ejection holes 88 communicate with the sixth intra-blade passage 86c on the most trailing side Db, in other words, the rearmost intra-blade passage 86c, among the plurality of intra-blade passages 86 in the second cooling air passage 80, and extend from the rearmost intra-blade passage 86c to the trailing edge 53b.

The number of intra-blade passages 86 in the second cooling air passage 80 according to the present embodiment is three, but the number of intra-blade passages 86 may be two or four or more. In addition, in a case where the number of intra-blade passages 86 in the second cooling air passage 80 is odd as in the present embodiment, the second cooling air passage 80 may have tip ejection holes that communicate with the end of the rearmost intra-blade passage 86c (sixth intra-blade passage 86c) on the tip side Dht and that are open on the tip surface 55. Further, the second cooling air passage 80 may have a plurality of film holes that communicate with the intra-blade passage 86 in any of the plurality of intra-blade passages 86 and that are open in the positive pressure surface 54p or the negative pressure surface 54n.

In the present embodiment, the cooling air Ac that flows into the main passage 61 from the inlet 63 of the main passage 61 in the first cooling air passage 60 flows into the blade body cooling passage portion 65 of the main passage 61 through the introduction passage portion 62 of the main passage 61. The cooling air Ac is convectively cooled around each of the intra-blade passages 66 in a process of flowing through the three intra-blade passages 66 in the blade body cooling passage portion 65. A part of the cooling air Ac flowing in the three intra-blade passages 66 is ejected to the outside along the positive pressure surface 54p or the negative pressure surface 54n from the plurality of film holes 74. A part of the cooling air Ac is convectively cooled around the film hole 74 in a process of flowing through the plurality of film holes 74. Further, the cooling air Ac ejected from the plurality of film holes 74 film-cools the positive pressure surface 54p or the negative pressure surface 54n. In the three intra-blade passages 66, a part of the cooling air Ac that flows into the first intra-blade passage 66a positioned on the downstream side of the flow of the cooling air Ac on the most leading side Df is ejected to the outside from the plurality of leading ejection holes 72. A part of the cooling air Ac is convectively cooled around the leading ejection holes 72 in a process of flowing through the plurality of leading ejection holes 72. Further, the cooling air Ac ejected from the plurality of leading ejection holes 72 suppresses direct collision of the high-temperature combustion gas with the leading edge peripheral portion 56 which is a part of the blade surface 52. Further, the remaining portion of the cooling air Ac that has flowed into the first intra-blade passage 66a is ejected to the outside from the tip ejection hole 71.

In the present embodiment, the cooling air Ac that flows into the main passage 81 from the inlet 83 of the main passage 81 in the second cooling air passage 80 flows into the blade body cooling passage portion 85 of the main passage 81 through the introduction passage portion 82 of the main passage 81. The cooling air Ac is convectively cooled around each of the intra-blade passages 86 in a process of flowing through the three intra-blade passages 86 in the blade body cooling passage portion 85. A part of the cooling air Ac flowing in the three intra-blade passages 86 is ejected to the outside through the plurality of trailing ejection holes 88 from the sixth intra-blade passage (rearmost intra-blade passage) 86c which is positioned on the most trailing side Db among the three intra-blade passages 86 and is positioned on the downstream side of the flow of the cooling air Ac. The cooling air Ac is convectively cooled around the trailing ejection holes 88 in a process of flowing through the plurality of trailing ejection holes 88. Further, the cooling air Ac ejected from the plurality of trailing ejection holes 88 suppresses generation of a wake of the combustion gas on the trailing side Db of the trailing edge 53b.

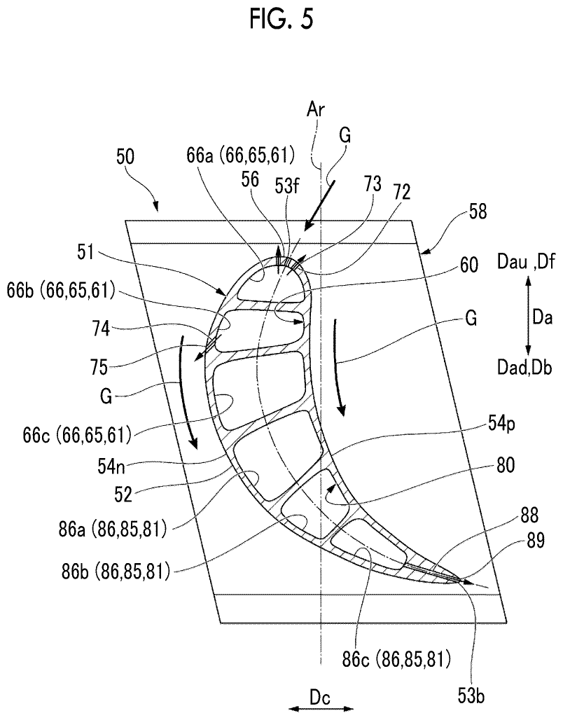

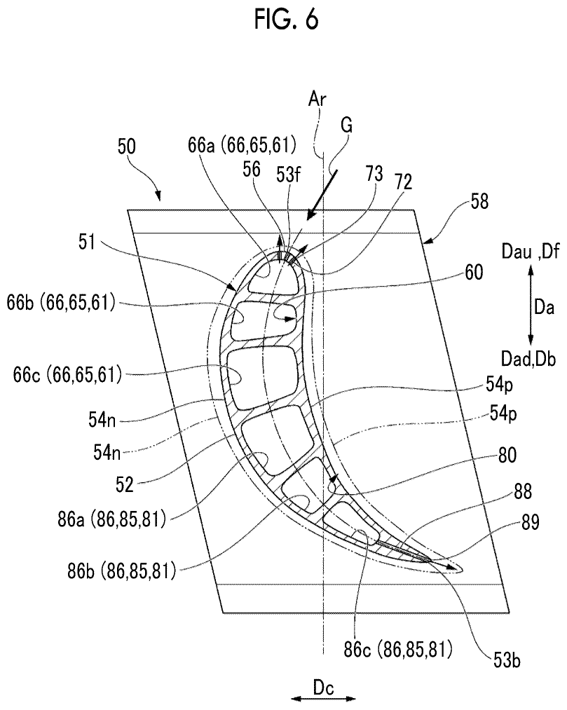

Meanwhile, a blade width which is a distance between the positive pressure surface 54p and the negative pressure surface 54n gradually increases from the tip side Dht of the blade body 51 toward the hub side Dhh. In addition, a distance between an inner surface of the intra-blade passage 66 and the blade surface 52 is a distance within a predetermined range from the viewpoint of cooling the blade surface 52. In this relationship, as illustrated in FIGS. 5 and 6, the widths of the plurality of intra-blade passages 66 extending in the blade height direction Dh gradually increase from the tip side Dht of the blade body 51 toward the hub side Dhh. In a case where the width of the intra-blade passage 66 gradually increases from the tip side Dht of the blade body 51 toward the hub side Dhh, a flow velocity of the cooling air Ac flowing through the intra-blade passage 66 is lower on the hub side Dhh than on the tip side Dht. Therefore, a heat transfer coefficient between the cooling air Ac flowing through the portion of the intra-blade passage 66 on the hub side Dhh and the blade body 51 is lower than a heat transfer coefficient between the cooling air Ac flowing through the portion of the intra-blade passage 66 on the tip side Dht and the blade body 51. Therefore, the convection cooling effect of the cooling air Ac flowing through the intra-blade passage 66 is low in the portion of the blade body 51 on the hub side Dhh.

Therefore, in the present embodiment, durability of the rotor blade 50 is increased by improving the film cooling effect on the portion on the hub side Dhh by setting the aperture ratio that is the area of the blade surface ejection port 75 per unit area on the hub side Dhh to be higher than the aperture ratio that is the area of the blade surface ejection port 75 per unit area on the tip side Dht, based on the middle position of the blade body 51 in the blade height direction Dh.

Since the blade body cooling passage portion 65 of the present embodiment has three intra-blade passages 66, the cooling air Ac flows from the hub side Dhh to the tip side Dht in the first intra-blade passage 66a on the most leading side Df. Therefore, the cooling air Ac on the tip side Dht in the first intra-blade passage 66a is heated more than the cooling air Ac on the hub side Dhh in the first intra-blade passage 66a.

Therefore, in the present embodiment, the aperture ratio that is the area of the leading ejection port 73 per unit area on the tip side Dht is set to be higher than the aperture ratio that is the area of the leading ejection port 73 per unit area on the hub side Dhh, based on the middle position of the blade height direction Dh in the blade body 51. As a result, in the present embodiment, a flow rate of the cooling air Ac ejected from the leading ejection port 73 on the tip side Dht is larger than a flow rate of the cooling air Ac ejected from the leading ejection port 73 on the hub side Dhh, and the durability of the rotor blade 50 can be increased.

In addition, in the present embodiment, the cooling air Ac flowing into the plurality of film holes 74 is the cooling air Ac that flows from the third intra-blade passage 66c on the most trailing side Db to the downstream side portion of the second intra-blade passage 66b among the three intra-blade passages 66, and is the cooling air Ac that has already been heated to some extent. The downstream side here is the downstream side of the flow of the cooling air Ac. In the present embodiment, as described above, since the cooling air Ac that has been heated to some extent and that has a low convection cooling effect is used as the air for film cooling, the blade surface 52 can be efficiently cooled without wasting the cold cooling air Ac. In addition, in the present embodiment, the cooling air Ac flowing into the plurality of leading ejection holes 72 is the cooling air Ac that flows from the third intra-blade passage 66c on the most trailing side Db to the first intra-blade passage 66a among the three intra-blade passages 66, and is the cooling air Ac that has already been considerably heated. In the present embodiment, as described above, since the cooling air Ac that has been considerably heated and that has a low convection cooling effect is used as the cooling air for the leading edge peripheral portion 56 which is a part of the blade surface 52, the blade surface 52 can be efficiently cooled without wasting the cold cooling air Ac.

The flow velocity of the combustion gas G flowing along the negative pressure surface 54n which is a protruding curved surface is higher than the flow velocity of the combustion gas G flowing along the positive pressure surface 54p which is a recessed curved surface. Therefore, a heat transfer coefficient between the combustion gas G flowing along the negative pressure surface 54n and the negative pressure surface 54n is higher than a heat transfer coefficient between the combustion gas G flowing along the positive pressure surface 54p and the positive pressure surface 54p. That is, the negative pressure surface 54n is more easily heated by the combustion gas G than the positive pressure surface 54p.

Therefore, in the present embodiment, the blade surface ejection port 75 is formed only on the negative pressure surface 54n, the negative pressure surface 54n is film-cooled, and the durability of the rotor blade 50 is improved. On the other hand, the blade surface ejection port 75 is not formed on the positive pressure surface 54p which is less likely to be heated by the combustion gas G than the negative pressure surface 54n, and the use of the cooling air Ac is suppressed.

Therefore, in the present embodiment, it is possible to increase the durability of the rotor blade 50 while suppressing the amount of the cooling air Ac used.

### Second Embodiment of Rotor Blade

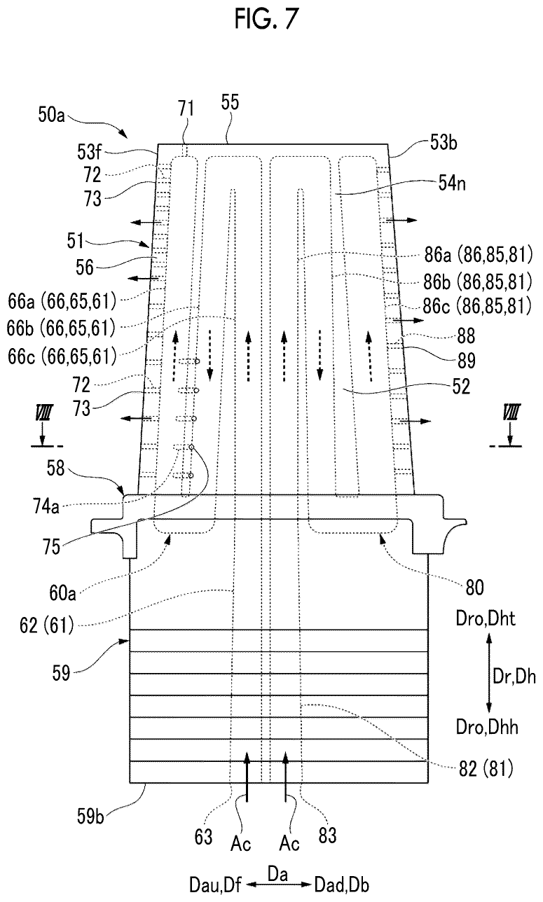

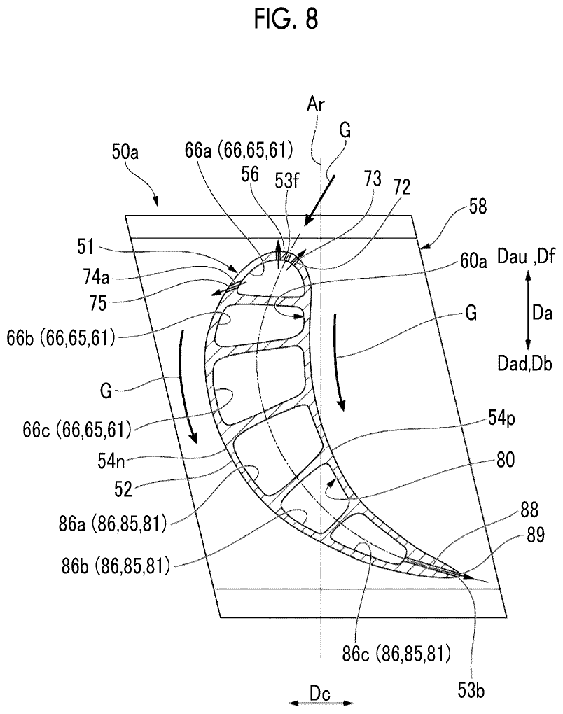

A second embodiment of the rotor blade will be described with reference to FIGS. 7 and 8.

A rotor blade 50a in the present embodiment includes a blade body 51, a platform 58, a first cooling air passage 60a, and a second cooling air passage 80, similarly to the rotor blade 50 in the first embodiment. The configuration of the rotor blade 50a in the present embodiment, except for the configuration of the first cooling air passage 60a, is the same as the configuration of the rotor blade 50 in the first embodiment, except for the configuration of the first cooling air passage 60.

The first cooling air passage 60a according to the present embodiment also has a main passage 61, a tip ejection hole 71, a plurality of leading ejection holes 72, and a plurality of film holes 74a, similarly to the first cooling air passage 60 according to the first embodiment. The main passage 61 is open in a bottom surface 59b of a blade root 59 and has an inlet 63 into which cooling air Ac from a rotor shaft 42 can flow. The main passage 61 includes an introduction passage portion 62 extending from the inlet 63 to a boundary between the platform 58 and the blade body 51 in a blade height direction Dh, and a blade body cooling passage portion 65 having three intra-blade passages 66 extending in the blade height direction Dh in the blade body 51, similarly to the main passage 61 of the first cooling air passage 60 in the first embodiment. The intra-blade passages 66 adjacent to each other among the three intra-blade passages 66 communicate with each other at one end out of an end on a hub side Dhh and an end on a tip side Dht such that the blade body cooling passage portion 65 configures one serpentine passage in which the passage meanders in the blade height direction Dh, similarly to the blade body cooling passage portion 65 of the first cooling air passage 60 in the first embodiment. The tip ejection hole 71 communicates with the end of the first intra-blade passage 66a on the tip side Dht and is open on the tip surface 55 similarly to the tip ejection hole 71 of the first cooling air passage 60 in the first embodiment. All of the plurality of leading ejection holes 72 have leading ejection ports 73 that are open in a leading edge peripheral portion 56, which is a portion including the leading edge 53f and facing the leading side Df, in the blade surface 52 and communicate with the first intra-blade passage 66a, similarly to the plurality of leading ejection holes 72 of the first cooling air passage 60 in the first embodiment.

The plurality of film holes 74a in the present embodiment also have a blade surface ejection port 75 that is open in the negative pressure surface 54n in the blade surface 52 except for the leading edge peripheral portion 56, similarly to the plurality of film holes 74 in the first embodiment. Also in the present embodiment, the aperture ratio which is the area of the blade surface ejection port 75 per unit area in the portion on the hub side Dhh is higher than the aperture ratio which is the area of the blade surface ejection port 75 per unit area in the portion on the tip side Dht, based on the middle position in the blade height direction Dh on the negative pressure surface 54n. However, the plurality of film holes 74a in the present embodiment communicate with the first intra-blade passages 66a on the most leading side Df among the three intra-blade passages 66.

Therefore, the cooling air Ac flowing into the plurality of film holes 74a is the cooling air Ac that has flowed from the third intra-blade passage 66c on the most trailing side Db to the second intra-blade passage 66b and then to an upstream side portion of the first intra-blade passage 66a among the three intra-blade passages 66, and is the cooling air Ac that has already been considerably heated. In the present embodiment, as described above, since the cooling air Ac that has been considerably heated and that has a low convection cooling effect is used as the air for film cooling, the blade surface 52 can be efficiently cooled as compared with the first embodiment without wasting the cold cooling air Ac.

### Third Embodiment of Rotor Blade

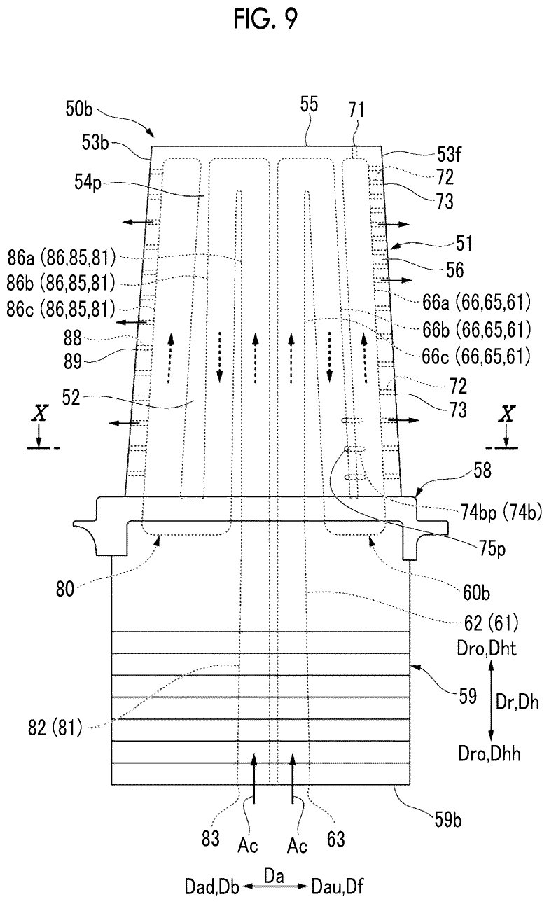

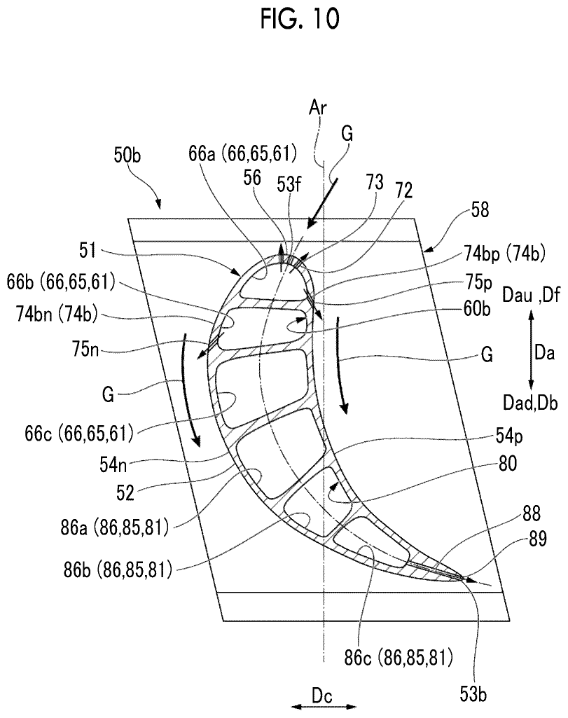

A third embodiment of the rotor blade will be described with reference to FIGS. 9 and 10. FIG. 9 is a side view of the rotor blade as in FIG. 3 and FIG. 7, but is a side view of the rotor blade as viewed from a positive pressure surface side instead of a side view of the rotor blade as viewed from a negative pressure surface side.

A rotor blade 50b in the present embodiment includes a blade body 51, a platform 58, a first cooling air passage 60b, and a second cooling air passage 80, similarly to the rotor blade 50 in the first embodiment. The configuration of the rotor blade 50b in the present embodiment, except for the configuration of the first cooling air passage 60b, is the same as the configuration of the rotor blade 50 in the first embodiment, except for the configuration of the first cooling air passage 60.

The first cooling air passage 60b according to the present embodiment also has a main passage 61, a tip ejection hole 71, a plurality of leading ejection holes 72, and a plurality of film holes 74b, similarly to the first cooling air passage 60 according to the first embodiment. The main passage 61 is open in a bottom surface 59b of a blade root 59 and has an inlet 63 into which cooling air Ac from a rotor shaft 42 can flow. The main passage 61 includes an introduction passage portion 62 extending from the inlet 63 to a boundary between the platform 58 and the blade body 51 in a blade height direction Dh, and a blade body cooling passage portion 65 having three intra-blade passages 66 extending in the blade height direction Dh in the blade body 51, similarly to the main passage 61 of the first cooling air passage 60 in the first embodiment. The intra-blade passages 66 adjacent to each other among the three intra-blade passages 66 communicate with each other at one end of an end on a hub side Dhh and an end on a tip side Dht so that the blade body cooling passage portion 65 configures one serpentine passage in which the passage meanders in the blade height direction Dh, similarly to the blade body cooling passage portion 65 of the first cooling air passage 60 in the first embodiment. The tip ejection hole 71 communicates with the end of the first intra-blade passage 66a on the tip side Dht and is open on the tip surface 55 similarly to the tip ejection hole 71 of the first cooling air passage 60 in the first embodiment. All of the plurality of leading ejection holes 72 have leading ejection ports 73 that are open in a leading edge peripheral portion 56, which is a portion including the leading edge 53f and facing the leading side Df, in the blade surface 52 and communicate with the first intra-blade passage 66a, similarly to the plurality of leading ejection holes 72 of the first cooling air passage 60 in the first embodiment.

The plurality of film holes 74b in the present embodiment include a plurality of negative pressure-side film holes 74bn and a plurality of positive pressure-side film holes 74bp. The plurality of negative pressure-side film holes 74bn have negative pressure surface ejection ports 75n as blade surface ejection ports that are open in the negative pressure surface 54n excluding the leading edge peripheral portion 56 in the blade surface 52. In addition, the plurality of positive pressure-side film holes 74bp have positive pressure surface ejection ports 75p as the blade surface ejection ports that are open in the positive pressure surface 54p in the blade surface 52 excluding the leading edge peripheral portion 56. The negative pressure-side film hole 74bn communicates with the second intra-blade passage 66b, similarly to the film hole 74 in the first embodiment. Meanwhile, the positive pressure-side film hole 74bp communicates with the first intra-blade passage 66a.

Also in the present embodiment, the aperture ratio which is the area of the negative pressure surface ejection port 75n per unit area in the portion on the hub side Dhh is higher than the aperture ratio which is the area of the negative pressure surface ejection port 75n per unit area in the portion on the tip side Dht, based on the middle position of the negative pressure surface 54n in the blade height direction Dh. In addition, the aperture ratio which is the area of the positive pressure surface ejection port 75p per unit area in the portion on the hub side Dhh is higher than the aperture ratio which is the area of the positive pressure surface ejection port 75p per unit area in the portion on the tip side Dht, based on the middle position of the positive pressure surface 54p in the blade height direction Dh. However, the number of the plurality of positive pressure-side film holes 74bp is smaller than the number of the plurality of negative pressure-side film holes 74bn.

In the present embodiment, not only the negative pressure surface 54n but also the positive pressure surface 54p can be film-cooled. As described above, in the present embodiment, not only the negative pressure surface 54n but also the positive pressure surface 54p are film-cooled, so that the amount of cooling air Ac used is increased as compared with each of the above-described embodiments. Therefore, in the present embodiment, the number of positive pressure-side film holes 74bp for film-cooling the positive pressure surface 54p that is less likely to be heated by the combustion gas G than the negative pressure surface 54n is smaller than the number of negative pressure-side film holes 74bn. Further, in the present embodiment, the positive pressure-side film holes 74bp communicate with the first intra-blade passage 66a, and the positive pressure surface 54p is efficiently film-cooled without wasting the cold cooling air Ac.

It should be noted that the present embodiment is a modification example of the first embodiment, but in the second embodiment as well, a plurality of positive pressure-side film holes may be provided in addition to the plurality of negative pressure-side film holes as in the present embodiment.

### Other Modification Examples of Rotor Blade

In each of the above-described embodiments and modification examples, the number of ejection ports in the portion on the hub side Dhh and the number of ejection ports in the portion on the tip side Dht are different from each other in order to make the aperture ratio of the ejection port in the portion on the hub side Dhh different from the aperture ratio of the ejection port in the portion on the tip side Dht. However, by making an opening area of each of the ejection ports in the portion on the hub side Dhh different from an opening area of each of the ejection ports in the portion on the tip side Dht, the aperture ratio of the ejection ports in the portion on the hub side Dhh and the aperture ratio of the ejection ports in the portion on the tip side Dht may be made different from each other.

In addition, all of the above-described embodiments are directed toward the first stage rotor blade. However, for example, the present invention may be directed toward a second stage rotor blade, in addition to the first stage rotor blade.

The present disclosure is not limited to the embodiments and the modification examples described above. Various additions, changes, replacements, or partial deletions can be made within the scope that does not deviate from the conceptual idea and the gist of the present disclosure derived from the contents defined in the scope of the appended claims and the equivalent thereof.

### Additional Remarks

For example, the rotor blade in the above-described embodiments and modification examples is understood as follows.

(1) In the first aspect, a rotor blade includes a blade body 51 that has a cross section forming an airfoil and that extends in a blade height direction Dh including a direction component perpendicular to the cross section, a platform 58 that is provided at an end on a hub side Dhh of the blade body 51, out of a tip side Dht and the hub side Dhh in the blade height direction Dh, a blade root 59 that is provided on the hub side Dhh of the platform 58, and cooling air passages 60, 60a, and 60b that are formed over the blade root 59, the platform 58, and the blade body 51 and through which cooling air Ac is allowed to be circulated. The blade body 51 has a blade surface 52 facing a direction having a direction component perpendicular to the blade height direction Dh, and a tip surface SS facing the tip side Dht in the blade height direction Dh. The blade surface 52 has a leading edge 53f and a trailing edge 53b extending in the blade height direction Dh, and a positive pressure surface 54p and a negative pressure surface 54n spreading from the leading edge 53f to the trailing edge 53b. The cooling air passages 60, 60a, and 60b include a main passage 61 that has an inlet 63 which is open in a surface of the blade root 59 and into which cooling air Ac is able to flow, a plurality of leading ejection holes 72 that include a leading ejection port 73 open in a leading edge peripheral portion 56, which is a portion that includes the leading edge 53f and faces a leading side Df which is a side of the leading edge 53f with respect to the trailing edge 53b, in the blade surface 52, and through which the cooling air Ac that has been passed through the main passage 61 is allowed to be ejected from the leading ejection ports 73, and a plurality of film holes 74, 74a, and 74b that include blade surface ejection ports 75, 75n, and 75p which exclude the leading edge peripheral portion 56, in the blade surface 52, and are open in at least one blade surface 52 of the positive pressure surface 54p and the negative pressure surface 54n, and through which the cooling air Ac that has been passed through the main passage 61 is allowed to be ejected to an outside along the at least one blade surface 52 from the blade surface ejection ports 75, 75n, and 75p. The main passage 61 includes an introduction passage portion 62 that extends from the inlet 63 to a boundary between the platform 58 and the blade body 51, and a blade body cooling passage portion 65 that has three or more odd-numbered intra-blade passages 66 extending in the blade height direction Dh in the blade body 51. The odd-numbered intra-blade passages 66 are arranged from the introduction passage portion 62 to the leading side Df along a camber line CL of the blade body 51. Intra-blade passages 66 adjacent to each other among the odd-numbered intra-blade passages 66 communicate with each other at one end out of an end on the hub side Dhh and an end on the tip side Dht such that the blade body cooling passage portion 65 configures one serpentine passage in which a passage meanders in the blade height direction Dh. The plurality of leading ejection holes 72 communicate with a first intra-blade passage 66a positioned on a most leading side Df among the odd-numbered intra-blade passages 66. The plurality of film holes 74, 74a, and 74b communicate with at least one intra-blade passage 66 of the first intra-blade passage 66a and a second intra-blade passage 66b adjacent to the first intra-blade passage 66a among the odd-numbered intra-blade passages 66. An aperture ratio which is an area of the blade surface ejection ports 75, 75n, and 75p per unit area on the hub side Dhh is higher than an aperture ratio which is an area of the blade surface ejection ports 75, 75n, and 75p per unit area on the tip side Dht, based on a middle position of the blade body 51 in the blade height direction Dh.

In the present aspect, the cooling air Ac that flows into the main passage 61 from the inlet 63 of the main passage 61 in the cooling air passages 60, 60a, and 60b flows into the blade body cooling passage portion 65 of the main passage 61 through the introduction passage portion 62 of the main passage 61. The cooling air Ac is convectively cooled around each of the intra-blade passages 66 in a process of flowing through the three or more odd-numbered intra-blade passages 66 in the blade body cooling passage portion 65.

A part of the cooling air Ac flowing through the three or more odd-numbered the intra-blade passages 66 is ejected to the outside along the positive pressure surface 54p or the negative pressure surface 54n from the plurality of film holes 74, 74a, and 74b. A part of the cooling air Ac is convectively cooled around the film holes 74, 74a, and 74b in a process of flowing through the plurality of film holes 74, 74a, and 74b. Further, the cooling air Ac ejected from the plurality of film holes 74, 74a, and 74b film-cools the positive pressure surface 54p or the negative pressure surface 54n. A part of the cooling air Ac that flows into the first intra-blade passage 66a positioned on the downstream side of the flow of the cooling air Ac on the most leading side Df among the three or more odd-numbered intra-blade passages 66 is ejected to the outside from the plurality of leading ejection holes 72. A part of the cooling air Ac is convectively cooled around the leading ejection holes 72 in a process of flowing through the plurality of leading ejection holes 72. Further, the direct collision of the high-temperature combustion gas G with the leading edge peripheral portion 56 which is a part of the blade surface 52 is suppressed by the cooling air Ac ejected from the plurality of leading ejection holes 72.

Meanwhile, a blade width which is a distance between the positive pressure surface 54p and the negative pressure surface 54n gradually increases from the tip side Dht of the blade body 51 toward the hub side Dhh. In addition, a distance between an inner surface of the intra-blade passage 66 and the blade surface 52 is a distance within a predetermined range from the viewpoint of cooling the blade surface 52. In this relationship, the widths of the plurality of intra-blade passages 66 extending in the blade height direction Dh gradually increase from the tip side Dht of the blade body 51 toward the hub side Dhh. In a case where the width of the intra-blade passage 66 gradually increases from the tip side Dht of the blade body 51 toward the hub side Dhh, a flow velocity of the cooling air Ac flowing through the intra-blade passage 66 is lower on the hub side Dhh than on the tip side Dht. Therefore, a heat transfer coefficient between the cooling air Ac flowing through the portion of the intra-blade passage 66 on the hub side Dhh and the blade body 51 is lower than a heat transfer coefficient between the cooling air Ac flowing through the portion of the intra-blade passage 66 on the tip side Dht and the blade body 51. Therefore, the convection cooling effect of the cooling air Ac flowing through the intra-blade passage 66 is low in the portion of the blade body 51 on the hub side Dhh.

Therefore, in the present aspect, the aperture ratio which is the area of the blade surface ejection ports 75, 75n, and 75p per unit area on the hub side Dhh is set to be higher than the aperture ratio which is the area of the blade surface ejection ports 75, 75n, and 75p per unit area on the tip side Dht, based on the middle position of the blade height direction Dh in the blade body 51, and the film cooling effect in the portion on the hub side Dhh is improved, thereby improving the durability of the rotor blade 50.

In addition, in the present aspect, the cooling air Ac flowing into the plurality of film holes 74, 74a, and 74b is the cooling air Ac that flows from the intra-blade passage 66 on the most trailing side Db to at least the downstream side portion of the second intra-blade passage 66b among the three or more odd-numbered intra-blade passages 66, and is the cooling air Ac that has already been heated to some extent. The downstream side here is the downstream side of the flow of the cooling air Ac. In the present aspect, as described above, since the cooling air Ac that has been heated to some extent and that has a low convection cooling effect is used as the air for film cooling, the blade surface 52 can be efficiently cooled without wasting the cold cooling air Ac. Further, in the present aspect, the cooling air Ac that flows into the plurality of leading ejection holes 72 is the cooling air Ac that flows from the intra-blade passage 66 on the most trailing side Db to the first intra-blade passage 66a among the three or more odd-numbered intra-blade passages 66, and is the cooling air Ac that has already been considerably heated. The upstream side here is the upstream side of the flow of the cooling air Ac. In the present aspect, as described above, since the cooling air Ac that has been considerably heated and that has a low convection cooling effect is used as the cooling air for the leading edge peripheral portion 56 that is a part of the blade surface 52, the blade surface 52 can be efficiently cooled without wasting the cold cooling air Ac.

Therefore, in the present aspect, it is possible to increase the durability of the rotor blade while suppressing the amount of the cooling air Ac used.

(2) In the rotor blade according to a second aspect, in the rotor blade according to the first aspect, the number of the blade surface ejection ports 75, 75n, and 75p is more on the hub side Dhh than on the tip side Dht, based on the middle position of the blade body 51 in the blade height direction Dh.

(3) In the rotor blade according to a third aspect, in the rotor blade according to the first aspect, the blade surface ejection ports 75, 75n, and 75p are present only on the hub side Dhh and are not present on the tip side Dht, based on the middle position of the blade height direction Dh in the blade body 51.

(4) In the rotor blade according to a fourth aspect, in the rotor blade according to any one of the first to third aspects, the plurality of film holes 74a communicate with only the first intra-blade passage 66a among the odd-numbered intra-blade passages 66.

In the present aspect, the cooling air Ac flowing into the plurality of film holes 74a is cooling air Ac that flows from the intra-blade passage 66 on the most trailing side Db among the three or more odd-numbered intra-blade passages 66 to a portion of the first blade passage 66a on the upstream side through the second intra-blade passage 66b, and is the cooling air Ac that has already been considerably heated. In the present aspect, as described above, since the cooling air Ac that has been considerably heated and that has a low convection cooling effect is used as the air for film cooling, the blade surface 52 can be efficiently cooled without wasting the cold cooling air Ac.

(5) In the rotor blade according to a fifth aspect, in the rotor blade according to any one of the first to fourth aspects, the blade surface ejection port 75 is formed only in the negative pressure surface 54n.

The flow velocity of the combustion gas G flowing along the negative pressure surface 54n which is a protruding curved surface is higher than the flow velocity of the combustion gas G flowing along the positive pressure surface 54p which is a recessed curved surface. Therefore, a heat transfer coefficient between the combustion gas G flowing along the negative pressure surface 54n and the negative pressure surface 54n is higher than a heat transfer coefficient between the combustion gas G flowing along the positive pressure surface 54p and the positive pressure surface 54p. That is, the negative pressure surface 54n is more easily heated by the combustion gas G than the positive pressure surface 54p.

Therefore, in the present aspect, the blade surface ejection port 75 is formed only on the negative pressure surface 54n, the negative pressure surface 54n is film-cooled, and the durability of the rotor blade 50 is improved. Meanwhile, the blade surface ejection port is not formed on the positive pressure surface 54p that is less likely to be heated by the combustion gas G than the negative pressure surface 54n, and the use of the cooling air Ac is suppressed.

(6) In the rotor blade according to a sixth aspect, in the rotor blade according to any one of the first to fifth aspects, an aperture ratio which is an area of the leading ejection port 73 per unit area on the tip side Dht is higher than an aperture ratio which is an area of the leading ejection port 73 per unit area on the hub side Dhh, based on the middle position of the blade body 51 in the blade height direction Dh.

Since the blade body cooling passage portion 65 of the present aspect has the three or more odd-numbered intra-blade passages 66, the cooling air Ac flows from the hub side Dhh to the tip side Dht in the first intra-blade passage 66a on the most leading side Df. Therefore, the cooling air Ac on the tip side Dht in the first intra-blade passage 66a is heated more than the cooling air Ac on the hub side Dhh in the first intra-blade passage 66a.

Therefore, in the present aspect, the aperture ratio that is the area of the leading ejection port 73 per unit area on the tip side Dht is set to be higher than the aperture ratio that is the area of the leading ejection port 73 per unit area on the hub side Dhh, based on the middle position of the blade body 51 in the blade height direction Dh. As a result, in the present aspect, the flow rate of the cooling air Ac ejected from the leading ejection port 73 on the tip side Dht is larger than the flow rate of the cooling air Ac ejected from the leading ejection port 73 on the hub side Dhh, and the durability of the rotor blade 50 can be increased.

(7) In the rotor blade according to a seventh aspect, in the rotor blade according to any one of the first to sixth aspects, the cooling air passages 60, 60a, and 60b communicate with an end of the first intra-blade passage 66a on the tip side Dht and have a tip ejection hole 71 capable of ejecting cooling air Ac that has been passed through the first intra-blade passage 66a from the tip surface 55.

Since the blade body cooling passage portion 65 of the present aspect has the three or more odd-numbered intra-blade passages 66, the cooling air Ac flows from the hub side Dhh to the tip side Dht in the first intra-blade passage 66a on the most leading side Df. In a case where the tip ejection hole 71 is not provided, the flow of the cooling air Ac is delayed at the portion of the first intra-blade passage 66a on the tip side Dht, and the convection cooling effect at this portion on the tip side Dht is reduced. Therefore, in the present aspect, by providing the tip ejection hole 71, the flow of the cooling air Ac in the portion of the first intra-blade passage 66a on the tip side Dht is ensured, and the deterioration of the convection cooling effect in the portion on the tip side Dht is suppressed.

(8) In the rotor blade according to an eighth aspect, in the rotor blade according to any one of the first to seventh aspects, the rotor blade includes a second cooling air passage 80 that is formed over the blade root 59, the platform 58, and the blade body 51 in addition to the first cooling air passages 60, 60a, and 60b which are the cooling air passages 60, 60a, and 60b and through which cooling air Ac is allowed to be circulated. The second cooling air passage 80 is disposed on a trailing side Db which is a side of the trailing edge 53b with respect to the leading edge 53f based on the first cooling air passages 60, 60a, and 60b, and includes a main passage 81 having an inlet 83 which is open on the surface of the blade root 59 and through which cooling air Ac is able to flow, and a plurality of trailing ejection holes 88 having trailing ejection ports 89 through which the cooling air Ac that has been passed through the main passage 81 is allowed to be ejected to the outside from the trailing edge 53b. The main passage 81 in the second cooling air passage 80 includes an introduction passage portion 82 that extends from the inlet 83 in the second cooling air passage 80 to the boundary between the platform 58 and the blade body 51, and a blade body cooling passage portion 85 that has a plurality of intra-blade passages 86 extending in the blade height direction Dh in the blade body 51. The plurality of intra-blade passages 86 in the second cooling air passage 80 are arranged from the introduction passage portion 82 to the trailing side Db in the second cooling air passage 80 along the camber line CL of the blade body 51. The intra-blade passages 86 adjacent to each other among the plurality of intra-blade passages 86 in the second cooling air passage 80 communicate with each other at one end out of an end on the hub side Dhh and an end on the tip side Dht such that the blade body cooling passage portion 85 in the second cooling air passage 80 configures one serpentine passage in which a passage meanders in the blade height direction Dh. The plurality of trailing ejection holes 88 communicate with a rearmost intra-blade passage 86c on a most trailing side Db among the plurality of intra-blade passages 86 in the second cooling air passage 80.

In the present aspect, in a process in which the cooling air Ac flows through the plurality of intra-blade passages 86 of the second cooling air passage 80, the cooling air Ac flows around each intra-blade passage 86 to perform convection cooling. A part of the cooling air Ac flowing through the rearmost intra-blade passage 86c on the most trailing side Db among the plurality of intra-blade passages 86 is ejected to the outside from the plurality of trailing ejection holes 88. A part of the cooling air Ac is convectively cooled around the trailing ejection holes 88 in a process of flowing through the plurality of trailing ejection holes 88. Further, the cooling air Ac ejected from the plurality of trailing ejection holes 88 suppresses the generation of the wake of the combustion gas G on the trailing side Db of the trailing edge 53b.

For example, a gas turbine in the above-described embodiments and modification examples is understood as follows.

(9) In a ninth aspect, a gas turbine includes a plurality of the rotor blades according to any one of the first to eighth aspects, a rotor shaft 42 that is rotatable about an axis Ar and to which the plurality of rotor blades are attached to be arranged in a circumferential direction Dc with respect to the axis Ar, and a turbine casing 45 that covers an outer peripheral side of the plurality of rotor blades and the rotor shaft 42. The rotor blade is attached to the rotor shaft 42 such that the blade height direction Dh is a radial direction Dr with respect to the axis Ar, the hub side Dhh is a radial outer side Dro out of a radial inner side Dri and the radial outer side Dro in the radial direction Dr with respect to the axis Ar, and the leading side Df is an axial upstream side Dau out of the axial upstream side Dau and an axial downstream side Dad in an axial direction Da in which the axis Ar extends.

### Industrial Applicability

According to one aspect of the present disclosure, it is possible to increase the durability of the rotor blade while suppressing the amount of cooling air used.

### Reference Signs List

10: Gas turbine
11: Gas turbine rotor
14: Intermediate casing
15: Gas turbine casing
20: Compressor
21: Compressor rotor
22: Rotor shaft
23: Rotor blade row
25: Compressor casing
26: Stator blade row
30: Combustor
40: Turbine
41: Turbine rotor
42: Rotor shaft
43: Rotor blade row
45: Turbine casing
49: Combustion gas passage
50, 50a, 50b: Rotor blade
51: Blade body
52: Blade surface
53f: Leading edge
53b: Trailing edge
54n: Negative pressure surface
54p: Positive pressure surface
55: Tip surface
56: Leading edge peripheral portion
58: Platform
59: Blade root
59b: Bottom surface
60, 60a, 60b: First cooling air passage (or simply cooling air passage)
61: Main passage
62: Introduction passage portion
63: Inlet
65: Blade body cooling passage portion
66: Intra-blade passage
66a: First intra-blade passage
66b: Second intra-blade passage
66c: Third intra-blade passage
71: Tip ejection hole
72: Leading ejection hole
73: Leading ejection port
74, 74a, 74b: Film hole
74bn: Negative pressure-side film hole
74bp: Positive pressure-side film hole
75: Blade surface ejection port
75n: Negative pressure surface ejection port (blade surface ejection port)
75p: Positive pressure surface ejection port (blade surface ejection port)
80: Second cooling air passage
81: Main passage
82: Introduction passage portion
83: Inlet
85: Blade body cooling passage portion
86: Intra-blade passage
86a: Fourth intra-blade passage
86b: Fifth intra-blade passage
86c: Sixth intra-blade passage (rearmost intra-blade passage)
88: Trailing ejection hole
89: Trailing ejection port
A: Air
Ac: Cooling air
F: Fuel
G: Combustion gas
Ar: Axis
CL: Camber line
Da: Axial direction
Dau: Axial upstream side
Dad: Axial downstream side
Dc: Circumferential direction
Dr: Radial direction
Dri: Radial inner side
Dro: Radial outer side
Dh: Blade height direction
Dhh: Hub side
Dht: Tip side
Df: Leading side
Db: Trailing side

1. A rotor blade comprising:
a blade body that has a cross section forming an airfoil and that extends in a blade height direction including a direction component perpendicular to the cross section;
a platform that is provided at an end of a hub side of the blade body, out of a tip side and the hub side in the blade height direction;
a blade root that is provided on the hub side of the platform; and
a cooling air passage that is formed over the blade root, the platform, and the blade body and through which cooling air is allowed to be circulated,
wherein the blade body has a blade surface facing a direction having a direction component perpendicular to the blade height direction, and a tip surface facing the tip side in the blade height direction,
the blade surface has a leading edge and a trailing edge extending in the blade height direction, and a positive pressure surface and a negative pressure surface spreading from the leading edge to the trailing edge,
the cooling air passage includes
a main passage that has an inlet which is open on a surface of the blade root and into which cooling air is able to flow,
a plurality of leading ejection holes that include a leading ejection port open in a leading edge peripheral portion, which is a portion that includes the leading edge and faces a leading side which is a side of the leading edge with respect to the trailing edge, in the blade surface, and through which the cooling air that has been passed through the main passage is allowed to be ejected from the leading ejection ports, and
a plurality of film holes that include a blade surface ejection port which excludes the leading edge peripheral portion, in the blade surface, and is open in at least one blade surface of the positive pressure surface and the negative pressure surface, and through which the cooling air that has been passed through the main passage is allowed to be ejected to an outside along the at least one blade surface from the blade surface ejection port,
the main passage has an introduction passage portion that extends from the inlet to a boundary between the platform and the blade body, and a blade body cooling passage portion that has three or more odd-numbered intra-blade passages extending in the blade height direction in the blade body,
the odd-numbered intra-blade passages are arranged from the introduction passage portion to the leading side along a camber line of the blade body,
intra-blade passages adjacent to each other among the odd-numbered intra-blade passages communicate with each other at one end out of an end on the hub side and an end on the tip side such that the blade body cooling passage portion configures one serpentine passage in which a passage meanders in the blade height direction,
the plurality of leading ejection holes communicate with a first intra-blade passage positioned on a most leading side among the odd-numbered intra-blade passages,
the plurality of film holes communicate with at least one intra-blade passage of the first intra-blade passage and a second intra-blade passage adjacent to the first intra-blade passage among the odd-numbered intra-blade passages, and
an aperture ratio which is an area of the blade surface ejection port per unit area on the hub side is higher than an aperture ratio which is an area of the blade surface ejection port per unit area on the tip side, based on a middle position of the blade body in the blade height direction.

2. The rotor blade according to claim 1, wherein the number of the blade surface ejection ports is more on the hub side than on the tip side, based on the middle position of the blade body in the blade height direction.

3. The rotor blade according to claim 1, wherein the blade surface ejection port is present only on the hub side and is not present on the tip side, based on the middle position of the blade body in the blade height direction.

4. The rotor blade according to claim 1, wherein the plurality of film holes communicate with only the first intra-blade passage among the odd-numbered intra-blade passages.

5. The rotor blade according to claim 1, wherein the blade surface ejection port is formed in only the negative pressure surface.

6. The rotor blade according to claim 1, wherein an aperture ratio which is an area of the leading ejection port per unit area on the tip side is higher than an aperture ratio which is an area of the leading ejection port per unit area on the hub side, based on the middle position of the blade body in the blade height direction.

7. The rotor blade according to claim 1, wherein the cooling air passage communicates with an end of the first intra-blade passage on the tip side and has a tip ejection hole capable of ejecting cooling air that has been passed through the first intra-blade passage from the tip surface.

8. The rotor blade according to claim 1, further comprising a second cooling air passage that is formed over the blade root, the platform, and the blade body, in addition to a first cooling air passage that is the cooling air passage, and through which cooling air is allowed to be circulated,
wherein the second cooling air passage is disposed on a trailing side which is a side of the trailing edge with respect to the leading edge based on the first cooling air passage, and includes a main passage having an inlet which is open on the surface of the blade root and through which cooling air is able to flow, and a plurality of trailing ejection holes having trailing ejection ports through which the cooling air that has been passed through the main passage is allowed to be ejected to the outside from the trailing edge,
the main passage in the second cooling air passage includes an introduction passage portion that extends from the inlet in the second cooling air passage to the boundary between the platform and the blade body, and a blade body cooling passage portion having a plurality of intra-blade passages extending in the blade height direction in the blade body,
the plurality of intra-blade passages in the second cooling air passage are arranged from the introduction passage portion to the trailing side in the second cooling air passage along the camber line of the blade body,
intra-blade passages adjacent to each other among the plurality of intra-blade passages in the second cooling air passage communicate with each other at one end out of an end on the hub side and an end on the tip side such that the blade body cooling passage portion in the second cooling air passage configures one serpentine passage in which a passage meanders in the blade height direction, and
the plurality of trailing ejection holes communicate with a rearmost intra-blade passage on a most trailing side among the plurality of intra-blade passages in the second cooling air passage.

9. A gas turbine comprising:
a plurality of the rotor blades according to claim 1;
a rotor shaft that is rotatable about an axis and to which the plurality of rotor blades are attached to be arranged in a circumferential direction with respect to the axis; and
a turbine casing that covers an outer peripheral side of the plurality of rotor blades and the rotor shaft,
wherein the rotor blade is attached to the rotor shaft such that the blade height direction is a radial direction with respect to the axis, the hub side is a radial outer side out of a radial inner side and the radial outer side in the radial direction with respect to the axis, and the leading side is an axial upstream side out of the axial upstream side and an axial downstream side in an axial direction in which the axis extends.
